(19) United States
(12) Patent Application Publication
(10) Pub. No.: US 2025/0284519 A1
(43) Pub. Date: Sep. 11, 2025

(54) DATA CHANNEL BUILDING METHOD AND APPARATUS

(71) Applicant: CLOUD INTELLIGENCE ASSETS HOLDING (SINGAPORE) PRIVATE LIMITED, Singapore (SG)

(72) Inventors: Fang LU, Shanghai (CN); Yufei MAI, Shanghai (CN)

(21) Appl. No.: 18/850,473

(22) PCT Filed: Mar. 23, 2023
(86) PCT No.: PCT/CN2023/083386

§ 371 Date: Sep. 24, 2024

(30) Foreign Application Priority Data
Mar. 24, 2022 (CN) 202210296180.7

(51) Int. Cl. G06F 9/455; H04L 41/0895

(52) U.S. Cl. CPC G06F 9/45558; H04L 41/0895

(57) ABSTRACT

Embodiments of the present application provides a data channel building method and an apparatus, where the data channel building method is applied to a second virtual machine running in a first virtual machine, including: determining a first data transmission interface of the first virtual machine and a second data transmission interface for data transmission with the first virtual machine, where the first data transmission interface is communicated with the second data transmission interface; determining module information of a virtual network module according to attribute information of the second data transmission interface; generating the virtual network module according to the module information of the virtual network module; and building a target data transmission channel according to the first data transmission interface, the second data transmission interface and the virtual network module.

### CROSS-REFERENCE TO RELATED APPLICATIONS

The present application is a National Stage of International Application No. PCT/CN2023/083386, filed on Mar. 23, 2023, which claims priority to Chinese Patent Application No. 202210296180.7, entitled “DATA CHANNEL BUILDING METHOD AND APPARATUS”, filed to China National Intellectual Property Administration on Mar. 24, 2022. These applications are hereby incorporated by reference in their entireties.

### TECHNICAL FIELD

Embodiments of the present application relate to the field of computer technologies, and in particular, to a data channel building method.

### BACKGROUND

With the continuous development of computer technology and virtual machine technology, multiple virtual machines can be obtained through virtualization on physical machines, and communication and interaction is required between different virtual machines. In the prior art, communication and interaction between virtual machines are only allowed through local secure channels (based on vsock). However, as most of the current application programs use the network interface for data transmission, this design brings great challenges to the application program that needs to be deployed in the virtual machine, resulting in the application program deployed in a virtual machine being unable to perform data transmission with other virtual machines.

### SUMMARY

In view of this, the embodiments of this application provides a data channel building method. One or more embodiments of the present application also relate to a data transmission method, a data transmission apparatus, a data channel building apparatus, a computing device, a compute readable storage medium and a computer program, so as to solve the technical defects existing in the prior art.

According to a first aspect of the embodiments of this application, there is provided a data channel building method, which is applied to a second virtual machine running in a first virtual machine and includes:
determining a first data transmission interface of the first virtual machine and a second data transmission interface for data transmission with the first virtual machine, where the first data transmission interface is communicated with the second data transmission interface;
determining module information of a virtual network module according to attribute information of the second data transmission interface;
generating the virtual network module according to the module information of the virtual network module; and
building a target data transmission channel according to the first data transmission interface, the second data transmission interface and the virtual network module, where the target data transmission channel is a channel for data transmission between the first virtual machine and an application program in the second virtual machine.

According to a second aspect of the embodiments of this application, there is provided a data channel building apparatus, which is applied to a second virtual machine running in a first virtual machine and includes:
a first determining module, configured to determine a first data transmission interface of the first virtual machine and a second data transmission interface for data transmission with the first virtual machine, where the first data transmission interface is communicated with the second data transmission interface;
a second determining module, configured to determine module information of a virtual network module according to attribute information of the second data transmission interface;
a generation module, configured to generate the virtual network module according to the module information of the virtual network module; and
a building module, configured to build a target data transmission channel according to the first data transmission interface, the second data transmission interface and the virtual network module, where the target data transmission channel is a channel for data transmission between the first virtual machine and an application program in the second virtual machine.

According to a third aspect of the embodiments of this application, there is provided a data transmission method, which is applied to a second virtual machine running in a first virtual machine and includes:
receiving initial data to be processed sent by the first virtual machine through a target data transmission channel, where the target data transmission channel is built according to the data channel building method;
performing data type conversion on the initial data to be processed according to a virtual network module deployed in the second virtual machine to obtain target data to be processed;
processing the target data to be processed according to an application program deployed in the second virtual machine to obtain a data processing result;
performing data type conversion on the data processing result according to the virtual network module to obtain a converted data processing result; and
sending the converted data processing result to the first virtual machine through the target data transmission channel.

According to a fourth aspect of the embodiments of this application, there is provided a data transmission apparatus, which is applied to a second virtual machine running in a first virtual machine and includes:
a receiving module, configured to receive initial data to be processed sent by the first virtual machine through a target data transmission channel, where the target data transmission channel is built according to the data channel building method;
a first conversion module, configured to perform data type conversion on the initial data to be processed according to a virtual network module deployed in the second virtual machine to obtain target data to be processed;
a processing module, configured to process the target data to be processed according to an application program deployed in the second virtual machine to obtain a data processing result;
a second conversion module, configured to perform data type conversion on the data processing result according to the virtual network module to obtain a converted data processing result; and
a sending module, configured to send the converted data processing result to the first virtual machine through the target data transmission channel.

According to a fifth aspect of the embodiments of this application, there is provided a computing device, including:
a memory and a processor;
where the memory is configured to store computer-executable instructions, and the processor is configured to execute the computer executable instructions that, when executed by the processor, realize the steps of the data channel building method and the data transmission method.

According to a sixth aspect of the embodiments of this application, a computer-readable storage medium is provided, which stores computer-executable instructions that, which, when executed by a processor, realize the steps of the data channel building method and the data transmission method.

According to a seventh aspect of the embodiments of this application, there is provided a computer program, where when the computer program is executed in a computer, the computer is caused to execute the steps of the data channel building method and the data transmission method.

The data channel building method provided in this application is applied to a second virtual machine running in a first virtual machine, and includes: determining a first data transmission interface of the first virtual machine and a second data transmission interface for data transmission with the first virtual machine, where the first data transmission interface is communicated with the second data transmission interface; determining module information of a virtual network module according to attribute information of the second data transmission interface; generating the virtual network module according to the module information of the virtual network module; and building a target data transmission channel according to the first data transmission interface, the second data transmission interface and the virtual network module, where the target data transmission channel is a channel for data transmission between the first virtual machine and an application program in the second virtual machine.

Specifically, in the data channel building method, the virtual network module is generated in the second virtual machine, and the target data transmission channel is built based on the first data transmission interface of the first virtual machine, the second data transmission interface of the second virtual machine for data transmission with the first virtual machine, and the virtual network module, so that the application program in the second virtual machine can perform data transmission with the first virtual machine through the target data transmission channel, and the problem that the application program running in the second virtual machine cannot perform data transmission with the first virtual machine is avoided.

### BRIEF DESCRIPTION OF DRAWINGS

FIG. 1 is a schematic diagram of an application scenario of a data channel building method provided by an embodiment of this application.

FIG. 2 is a flowchart of a data channel building method provided by an embodiment of this application.

FIG. 3 is a process flow chart of a data channel building method provided by an embodiment of this application.

FIG. 4 is a schematic structural diagram of a data channel building apparatus provided by an embodiment of this application.

FIG. 5 is a process flow chart of a data transmission method provided by an embodiment of this application.

FIG. 6 is a schematic structural diagram of a data transmission apparatus provided by an embodiment of this application.

FIG. 7 is a structural block diagram of a computing device provided by an embodiment of this application.

### DESCRIPTION OF EMBODIMENTS

In the following description, numerous specific details are set forth to facilitate a thorough understanding of this application. However, this application can be implemented in many other ways different from those described here, and those skilled in the art can make similar promotion without violating the connotation of this application, therefore, this application is not limited by the specific implementation disclosed below.

Terminology used in one or more embodiments of this application is for the purpose of describing specific embodiments only and is not intended to limit one or more embodiments of this application. The singular forms “a”, “the” and “this” used in one or more embodiments of this application and the appended claims are also intended to include the plural forms, unless the context clearly indicates other meaning. It should also be understood that the term “and/or” used in one or more embodiments of this application refers to and includes any or all possible combinations of one or more associated listed items.

It should be understood that although that terms first, second, etc. may be used to describe various information in one or more embodiment of this application, these information should not be limited by these terms. These terms are only used to distinguish the same type of information from each other. For example, without departing from the scope of one or more embodiments of this application, the first can also be referred as the second, and similarly, the second can also be referred as the first. Depending on the context, the word “if” as used herein can be interpreted as “when” or “while” or “in response to a determination”.

First, the terminology related to one or more embodiments of this application is explained.
TEE—trusted execution environment.
PVM—Primary VM, master virtual machine.
EVM—Enclave VM, confidential virtual machine.
SEV—Secure Memory Encryption, a virtualization-based TEE technology realized by AMD.
TDX—Trust Domain Extensions, a virtualization-based TEE technology.
Vsock: a technology for data transmission between virtual machines.
Hypervisor: virtual machine monitor.
NGINX: a high-performance HTTP and reverse proxy web server.
MySQL: a relational database management system.
SPARK: a fast and universal computing engine designed for large-scale data processing.
TUN device: a virtual three-layer network device.
TCP: a connection-oriented, reliable and byte stream-based communication protocol on transport layer.
UDP: a connectionless transport protocol.
SDK: Software Development Toolkit.
Enclave ECall: a function.

With the continuous development of computer technology and virtual machine technology, many Internet companies will introduce various types of privacy-enhanced computing platform products to users in consideration of data security. In the privacy-enhanced computing platform products, Hypervisor technology is used to provide a fully isolated environment from other instances. After creating a virtualized isolated environment (for example, EVM) in an instance (for example, PVM), the PVM communicates with the isolated environment EVM through a local encryption channel vsock, for example, transmitting instructions to the isolated environment EVM through the local encryption channel vsock.

However, the current EVM runs an independent trusted operating system with no persistent storage and external network access and is only allowed to communicate with the main VM (that is, PVM) through the local secure communication channel (a secure channel created based on vsock). This design brings great challenges to the use of the current application programs.

Analysis shows that the current application program uses network interfaces, most of which are closely coupled with the logic and scenarios of the application program. In the cloud scenario, most application programs rely on network interfaces, such as NGINX, MySQL, SPARK, distributed machine learning and so on. However, the work of transplanting these application programs to a virtualized security environment has a great workload and difficulties. Thus, in order to solve the problem that application program can't directly adapt to the network interface, many Internet organizations perform a transformation of Enclave ECall using SDK for all portions of application program that use the network interface (similar to rewriting at a function call level). For example, a TEE SDK scheme provided by embodiments of this application requires to rewrite the network communication part of the application program, which further leads to a heavy transformation workload for the existing program and has great difficulties to get started. Although it is technically feasible, and can achieve that the application program deployed in the EVM communicates with the PVM. However, as most of the existing application programs in the cloud rely on network interfaces, very fine-grained API-level transformation on internal logic is required before they can be transplanted to the EVM. Therefore, with the widespread use of cloud native and containerized services, the promotion speed of confidential computing has been greatly reduced, which has become an obstacle to the promotion of virtualized isolated environment instances.

Based on this, in this application, a data channel building method is provided. This application also relates to a data channel building apparatus, a data transmission method, a data transmission apparatus, a computing device, a computer-readable storage medium and a computer program, which are described in detail in the following embodiments.

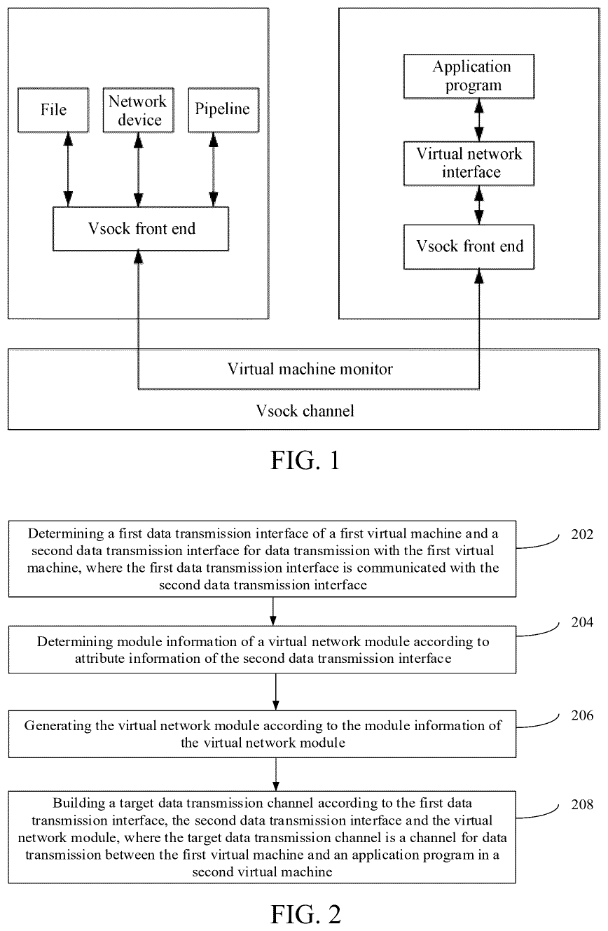

FIG. 1 shows a schematic diagram of an application scenario of a data channel building method provided by an embodiment of this application. The data channel building provided by the embodiments of this application can be understood as a method for supporting application programs to use network communication in the EVM. By implementing a virtualized network interface device (virtual network device) in the EVM, upward compatible network protocol stack and network programming model interface of the currently running application program in the EVM is realized. Meanwhile, a secure communication channel is established with PVM through a secure vsock data channel. The vsock data channel consists of vsock channel provided by virtualization Hypervisor, vsock front end in the EVM and vsock front end in the PVM. The EVM and the PVM can perform data transmission based on the secure vsock data channel.

Therefore, by establishing the virtual network interface on the EVM side and based on the advanced abstraction of vsock communication, the application programs in the EVM can complete a network usage that support external complexity, such as network forwarding, network mapping, and even processes of complex network monitoring and protection between the PVM and the EVM, and so on.

Specifically, referring to FIG. 1, in the data channel building method provided in this application, first, a virtual network device, that is, a virtual network card, is established in an EVM. This virtual network device can provide a compatible network environment for the EVM. Therefore, the application program in the EVM can easily use the unified network programming interface. Based on a TUN-based devices (that is, virtual network devices), data from the network layer, that is, IP packets, can be processed. TCP/UDP in the transport layer and various network protocol packages in the application layer can also be handled.

Secondly, after the creation of the virtual network device, it is necessary to build the virtual network device on the secure channel of vsock. By using the communication ability of vsock provided by virtualized Hypervisor, a secure and encrypted communication channel between the EVM and the PVM can be established.

Building the virtual network device on the vsock secure channel (that is, the above-mentioned secure vsock data channel) can be understood as configuring the network interface of the virtual network device together with the vsock front end of the EVM to form a secure and encrypted communication channel formed by connecting the virtual network device, the vsock front end of the EVM, the vsock channel provided by the Hypervisor and the vsock front end of the PVM. So that the application program in the EVM can transmit data to the PVM through this secure and encrypted communication channel.

Finally, at the PVM side, data (such as a file) can be transmitted to the data channel of the vsock through the vsock front end deployed in the PVM, where the data channel includes but is not limited to files, pipes, devices, network sockets, etc.

Based on this, the data channel building method provided in this application provides a complete and compatible network interface by implementing a standardized virtual network device in the EVM, so that application programs can run in the EVM without modification and realize data transmission with the PVM, which greatly reduces difficulties of usage of virtualized Enclave.

FIG. 2 shows a flowchart of a data channel building method provided by an embodiment of this application, which is applied to a second virtual machine running in a first virtual machine, and specifically includes the following steps.

Step 202: determining a first data transmission interface of the first virtual machine and a second data transmission interface for data transmission with the first virtual machine, where the first data transmission interface is communicated with the second data transmission interface.

The first virtual machine can be understood as a virtual machine that can support the operation of the second virtual machine, for example, the PVM in the above embodiment. In practical application, in the data channel building method provided in this application, a second virtual machine can be generated based on the virtualization of the virtual machine physical resources of the first virtual machine. The physical resources of the virtual machine can be understood as physical storage resources (such as memory resources) and physical computing resources (such as CPU resources) allocated to the first virtual machine from a host computer, and the second virtual machine can run in the first virtual machine. In addition, the second virtual machine can only perform data transmission with the first virtual machine. Accordingly, the second virtual machine can be understood as a virtual machine generated according to the physical resources of the virtual machine corresponding to the first virtual machine. For example, in a case that the first virtual machine is the PVM, the second virtual machine can be understood as the EVM. Accordingly, the first data transmission interface can be understood as an interface deployed in the first virtual machine, which can realize data transmission between the first virtual machine and the second virtual machine, for example, the vsock port deployed in the PVM in the above embodiment. Accordingly, the second data transmission interface can be understood as an interface deployed in the second virtual machine, which can realize data transmission between the first virtual machine and the second virtual machine, for example, the vsock port deployed in the EVM in the above embodiment. In practical application, a trusted operating system in which the EVM runs independently only allows communication with the main VM (the PVM) through the local secure channel (the secure channel created based on vsock).

Specifically, the second virtual machine provided in this application can determine the first data transmission interface of the first virtual machine and the second data transmission interface of the second virtual machine for data transmission with the first virtual machine. It should be noted that the first data transmission interface is communicated with the second data transmission interface.

In practical application, the first data transmission interface can communicate with the second data transmission interface through an initial data transmission channel. It can also be understood that the first data transmission interface and the second data transmission interface can be used as two ends of the initial data transmission channel. When data is input into the first data transmission interface, it is transmitted through the initial data transmission channel and finally output from the second data transmission interface. Alternatively, after data is input into the second data transmission interface, it is transmitted through the initial data transmission channel and finally output from the first data transmission interface. Thus, the data transmission between the PVM and the EVM is realized. The initial data transmission channel can be understood as a channel provided by Hypervisor for data transmission between virtual machines. For example, the vsock channel provided by the Hypervisor in FIG. 1 above.

Taking the scenario that the data channel building method provided in this application is used to realize EVM network interface communication in virtualized TEE as an example, the determination of the first data transmission interface of the first virtual machine and the second data transmission interface for data transmission with the first virtual machine will be further explained. The first virtual machine is the PVM, the first data transmission interface is a vsock port deployed in the PVM, the second virtual machine is the EVM, and the second data transmission interface is a vsock port deployed in EVM. Based on this, EVM can determine the vsock port deployed in the PVM and the vsock port for data transmission with the PVM, where the vsock port deployed in the EVM communicates with the vsock port deployed in the PVM.

It should be noted that in practical application, when EVM needs to realize data transmission between its own running application program and the PVM, it will determine the vsock port deployed in the PVM and its own vsock port for data transmission with the PVM. That is, when an application program is deployed in the EVM or needs to be deployed, because the application program needs to communicate with the PVM, the EVM needs to determine the vsock port deployed in the PVM and its own vsock port for data transmission with the PVM. It is convenient to build a target data transmission channel based on the vsock port deployed in the PVM and its own vsock port for data transmission with the PVM.

Step 204: determining module information of a virtual network module according to attribute information of the second data transmission interface.

The virtual network module can be understood as a module that can realize network data transmission capability in a virtual machine. For example, the virtual network module can be a virtual network device. The virtual network device can be a virtual network card.

When the second data transmission interface is a vsock front end, the attribute information of the second data transmission interface can be understood as a port type of the vsock front end. That is to say, the virtual network device created by the EVM needs to be adapted to the vsock front end. Therefore, in order to ensure a smooth communication between the created virtual network device and the vsock front end, it is necessary to determine device information of a matching virtual network device according to the port type of the vsock front end. On the other hand, in a case that the virtual network module is a virtual network device, the module information of the virtual network module can be understood as the device information of the virtual network device. In practical application, the device information includes configuration information of the virtual network interface, IP address and other information of the virtual network device that can be used to generate a virtual network device.

Specifically, in a process of creating the virtual network module by the second virtual machine, in order to ensure the compatibility between the virtual network module and the second data transmission interface, the attribute information of the second data transmission interface is obtained, and module information of the virtual network device is determined based on the attribute information.

Step 206: generating the virtual network module according to the module information of the virtual network module.

Following the above example, the virtual network module is a virtual network card, and the module information is configuration information needed to generate the virtual network card. Based on this, the EVM determines the virtual network card that matches the vsock front end based on port information of the vsock front end configured by itself, and generates the configuration information needed for the virtual network card. Then the EVM establishes a virtual network device, that is, a virtual network card, based on the configuration information. Therefore, a compatible network environment can be provided for the EVM through the virtual network card, and the application program running in EVM can conveniently use a unified network programming interface. Moreover, based on the current TUN device (virtual network card), data from the network layer, that is, IP packets can be processed. TCP/UDP in the transport layer and various network protocol packages in the application layer can also be handled.

Step 208: building a target data transmission channel according to the first data transmission interface, the second data transmission interface and the virtual network module, where the target data transmission channel is a channel for data transmission between the first virtual machine and an application program in the second virtual machine.

Specifically, the second data transmission interface in the second virtual machine communicates with the first data transmission interface. Based on this, the second virtual machine communicates with the second data transmission interface through the virtual network module, and builds the target data transmission channel for data transmission between the first virtual machine and the applications program in the second virtual machine according to the first data transmission interface and the second data transmission interface communicated with the first data transmission interface.

Further, in the embodiments provided in this application, the building the target data transmission channel according to the first data transmission interface, the second data transmission interface and the virtual network module includes:
determining interface identification information of the second data transmission interface;
communicating the second data transmission interface with the virtual network module according to the interface identification information; and
building the target data transmission channel according to the first data transmission interface, the second data transmission interface communicated with the first data transmission interface and the virtual network module communicated with the second data transmission interface.

The interface identification information can be understood as information uniquely identifying the second data transmission interface. For example, in the case that the second data transmission interface is a vsock front end, the interface identification information can be an interface number of the vsock front end.

Specifically, after generating the virtual network module, the second virtual machine can determine the interface identification information of the second data transmission interface, communicate the second data transmission interface with the virtual network module according to the interface identification information, and then build the target data transmission channel for data transmission between the first virtual machine and the application program in the second virtual machine based on the first data transmission interface, the second data transmission interface communicated with the first data transmission interface and the virtual network module communicated with the second data transmission interface, thus avoiding the problem that the application program cannot perform data transmission with other virtual machines.

Following the above example, the interface identification information of the second data transmission interface is the interface number of the vsock front end. Based on this, after creating the virtual network card, the EVM can determine the interface number of the vsock front end for data transmission with the PVM, and configure the vsock front end and the virtual network card together based on the interface number, so as to realize the communication between the vsock front end and the virtual network card in the EVM. After that, EVM builds a secure and encrypted communication channel based on the vsock front end deployed in the PVM, the vsock front end in the EVM communicated with the vsock front end deployed in the PVM and the virtual network card communicated with the vsock front end deployed in the EVM, so that the application program running in the EVM can perform data transmission with the PVM.

In the embodiments of this application, during the communication process between the vsock front end deployed in the EVM and the virtual network device deployed in the EVM, by configuring the network interface of the virtual network device and the vsock front end together, the communication between the vsock front end and the virtual network device is realized. The specific implementation method is as follows.

The communicating the second data transmission interface with the virtual network module according to the interface identification information includes:
determining a module data transmission interface of the virtual network module and module interface identification information of the module data transmission interface; and
communicating the second data transmission interface with the module data transmission interface of the virtual network module according to the interface identification information of the second data transmission interface and the module interface identification information.

In a case that the virtual network module is a virtual network device, the module data transmission interface can be understood as the virtual network interface in the virtual network device. Correspondingly, the module interface identification information can be understood as an interface number of the virtual network interface.

Specifically, after determining the interface identification information of the second data transmission interface, the second virtual machine can determine the module data transmission interface of the virtual network module and the module interface identification information of the module data transmission interface. Then, the second data transmission interface is communicated with the module data transmission interface of the virtual network module according to the interface identification information and the module interface identification information of the second data transmission interface.

Following the above example, the module interface identification information is the interface number of the virtual network interface. Based on this, the EVM can determine the virtual network interface in the virtual network card and the interface number of the virtual network interface after determining the interface number of the vsock front end for data transmission with the PVM. Then, based on the interface number of the virtual network interface and the interface number of the vsock front end, the EVM configures the virtual network interface and the vsock front end together, thus realizing the communication between the vsock front end and the virtual network card in the EVM.

In the embodiments of this application, the first data transmission interface communicates with the second data transmission interface through the initial data transmission channel, and then in a case that the virtual network module communicates with the second data transmission interface, the target data transmission channel can be built based on the initial data transmission channel, the first data transmission interface, the second data transmission interface and the virtual network module, thus realizing the data transmission between the application program running in the second virtual machine with the first virtual machine. The specific implementation method is as follows.

The building the target data transmission channel according to the first data transmission interface, the second data transmission interface communicated with the first data transmission interface and the virtual network module communicated with the second data transmission interface includes:
determining an initial data transmission channel corresponding to the first data transmission interface and the second data transmission interface, where the first data transmission interface is communicated with the second data transmission interface through the initial data transmission channel; and
building the target data transmission channel according to the initial data transmission channel, the first data transmission interface, the second data transmission interface and the virtual network module.

The initial data transmission channel can be understood as the vsock channel provided by the Hypervisor.

Specifically, the first data transmission interface communicates with the second data transmission interface through the initial data transmission channel. Based on this, the second virtual machine needs to determine the initial data transmission channel corresponding to the first data transmission interface and the second data transmission interface in the process of building the target data transmission channel, and build the target data transmission channel for data transmission between the first virtual machine and the application program in the second virtual machine based on the initial data transmission channel, the first data transmission interface communicated with the second data transmission interface through the initial data transmission channel, the second data transmission interface communicated with the first data transmission interface through the initial data transmission channel and the virtual network module communicated with the second data transmission interface, thus avoiding the problem that the application program cannot perform data transmission with other virtual machines.

In the embodiments of this application, after completing the target data transmission channel, data transmission between the application program running in the second virtual machine and the first virtual machine can be realized based on the target data transmission channel, thus ensuring the stable operation of the application program. The specific implementation method is as follows.

After the building the target data transmission channel according to the first data transmission interface, the second data transmission interface and the virtual network module, the method further includes steps 1 to 3.

Step 1: receiving initial data to be processed sent by the first virtual machine through the target data transmission channel.

In practical application, the application program deployed in the second virtual machine can be a web program, which needs data transmission based on virtual network devices to provide web services. Based on this, the second virtual machine can receive the initial data to be processed sent by the first virtual machine through the target data transmission channel after building the target data transmission channel based on the created virtual network device. The initial data to be processed can be understood as data that needs to be processed by the application program, such as instructions, files, call requests, data messages, data packets, etc. issued by the PVM.

Step 2, performing data type conversion on the initial data to be processed according to the virtual network module to obtain target data to be processed.

In practical application, the data type of the initial data to be processed received by the second virtual machine can be a data frame type. As the data frame cannot be processed by the virtual machine, it is necessary to convert the initial data to be processed of the data frame type into data that can be used by the virtual machine. Accordingly, the target data to be processed can be understood as data after data type conversion by the virtual network device.

Following the above example, the PVM inputs the data frame into its own deployed vsock port, and finally transmits it to the virtual network card of the EVM through the vsock channel provided by Hypervisor and the vsock port deployed in the EVM. After receiving the data frame transmitted by the PVM, the EVM can convert the data frame into data that can be recognized and used by the EVM through the virtual network card, thus facilitating a subsequent application program to process the data.

Further, in the embodiments provided in this application, in order to ensure the safe operation of the application program in the EVM, when the EVM receives the data transmitted from the outside, data verification processing is required for the data, and in a case that the verification is passed, the data is processed according to the application program, so as to avoid network attack on the application program running in the EVM. The specific implementation method is as follows.

Before the processing the target data to be processed according to the application program to obtain the data processing result, the method further includes:
determining a data verification unit corresponding to the virtual network module; and
performing data verification on the target data to be processed based on the data verification unit, and obtaining verified target data to be processed in a case that the data verification is passed.

The data verification unit can be understood as a unit in the second virtual machine for performing data verification on the received external data. In practical application, the data verification unit can be understood as a data detection tool, software program, script and so on, which is deployed in the EVM. For example, the data verification unit can be an iptables tool. The iptables tool can configure and set the virtual network interface of the EVM, so that the EVM can be better compatible with the ecology of the current network environment and provide convenience.

Specifically, after obtaining the target data to be processed, the second virtual machine can perform data verification on the target data to be processed which is received based on the virtual network module based on the data verification unit deployed in the second virtual machine and corresponding to the virtual network module, and obtain the verified target data to be processed in a case the data verification is passed. Subsequently, the verified target data to be processed is processed according to the application program, thus ensuring the security of the application program and preventing the application program running in EVM from being attacked by the network.

It should be noted that the vsock port in the PVM can be connected with the network device connected to the external network in the PVM. The network device connected to the external network has an external ip and an external port. The external data message is first transmitted to the PVM through network device, and then transmitted to the web program running in the EVM according to the target data transmission channel between the PVM and the EVM. There is vm security isolation between the EVM and the PVM, and the vsock security channel between the EVM and the PVM is an encrypted security channel. Therefore, when the PVM suffers a network attack, the web application program in the EVM will not be affected, thus protecting the security of the application program running in the EVM.

Step 3, processing the target data to be processed according to the application program.

Following the above example, after receiving the data sent by the PVM, where the dada could be a call request, the EVM can perform a processing on the call request based on the web application running in the EVM.

In practical application, when the web application performs processing on the call request, it can generate the data processing result of the application program for the call request. The data processing result can be set according to the actual application scenario, which is not specifically set in this application.

Further, in an embodiment provided in this application, the processing the target data to be processed according to the application program includes:
acquiring identification information of the application program from the target data to be processed, determining the application program according to the identification information; and
sending the target data to be processed to the application program for processing.

The identification information of the application program can be understood as information that uniquely identifies an application program, for example, the port number corresponding to the application program, or the name and ID of the application program. After receiving the target data to be processed sent by the first virtual machine, the second virtual machine can obtain identification information for the application program from the target data to be processed, and determine the application program corresponding to the target data to be processed according to the identification information. Then the target data to be processed will be sent to the corresponding application program for processing.

Following the above examples, the identification information of the application program is the port number of the web application. Based on this, after receiving the data sent by the PVM, the data could be a call request, the EVM determines the web application corresponding to the call request based on the port number of the web application carried in the call request. After that, the EVM determines the wen application corresponding to the call request, and sends the call request to the web application, and the web application performs a processing on the call request.

In an embodiment provided in this application, after the application program processing the target data to be processed, the second virtual machine can obtain the data processing result and send the data processing result to the first virtual machine, details of which is shown below: After the processing the target data to be processed according to the application program, the method further includes:
acquiring a data processing result, where the data processing result is a result obtained by processing the target data to be processed by the application program;
performing data type conversion on the data processing result according to the virtual network module to obtain a converted data processing result; and
sending the converted data processing result to the first virtual machine according to the target data transmission channel.

Following the above example, after the web application in the EVM processes the call request, a processing result for the call request can be generated, and then the web application can provide the processing result to the second virtual machine by transmitting data through the network Socket, and the second virtual machine converts the data type of the processing result into a data frame through the virtual network card, thus obtaining a processing result of the data frame type, and sending the processing result in the data frame type to the PVM through the target data transmission channel, thereby realizing the data communication between the EVM and the PVM.

In the data channel building method provided in an embodiment of this application, a virtual network device can also be set at the PVM side as an external network interface, and the EVM can be built as an internal network node, thus being completely compatible with the current network ecology and ensuring data transmission between the PVM and the EVM. The specific implementation method is as follows.

The virtual network module is deployed in the first virtual machine, and the virtual network module is communicated with the target data transmission channel.

Accordingly, the receiving the initial data to be processed sent by the first virtual machine through the target data transmission channel includes:
receiving the initial data to be processed sent by the first virtual machine through the virtual network module and the target data transmission channel communicated with the virtual network module.

In the embodiments provided in this application, a virtual network module is also deployed in the first virtual machine, and the virtual network module is communicated with the target data transmission channel, where deploying the virtual network module in the first virtual machine can be referred to the above-mentioned step of generating the virtual network module by the second virtual machine, which will not be repeated in this application. The virtual network module is communicated with the target data transmission channel, which can be understood as that the virtual network module is communicated with the first data transmission interface in the first virtual machine, so as to realize the communication between the virtual network module and the target data transmission channel, manners of communicating the virtual network module and the first data transmission interface can be referred to the above-mentioned step of communicating the virtual network module and the second data transmission interface in the second virtual machine, which will not be described in detail in this application.

Specifically, the virtual network module is deployed in the first virtual machine, and the virtual network module is communicated with the target data transmission channel. Based on this, the first virtual machine can send data to the application program in the second virtual machine through the virtual network module. The second virtual machine can receive the initial data to be processed sent by the first virtual machine through the virtual network module and the target data transmission channel communicated with the virtual network module, which is convenient for the subsequent application program running in the second virtual machine to receive and process the initial data to be processed.

In an embodiment provided in this application, the application program running in the second virtual machine can send data to the first virtual machine through the target data transmission channel, thus ensuring data interaction between the application program and the first virtual machine. The specific implementation method is as follows.

After the building the target data transmission channel according to the first data transmission interface, the second data transmission interface and the virtual network module, the method further includes:
acquiring initial data to be sent generated by the application program, where the initial data to be sent includes identification information of the first virtual machine;
performing data type conversion on the initial data to be sent according to the virtual network module to obtain target data to be sent; and
sending the target data to be sent to the first virtual machine through the target data transmission channel according to the identification information.

The identification information of the first virtual machine can be understood as information that uniquely identifies the first virtual machine, for example, the IP address of the virtual machine. Correspondingly, the data to be sent can be understood as the data that the application program needs to send to the first virtual machine, and the data to be sent can be set according to the actual application scenario, which is not specifically limited in this application. For example, the data to be sent can be files, pictures, data messages, instructions, data packets and other data.

Following the above examples, the EVM can receive the file data sent by the web application through network Socket data transmission, and convert the data type of the file data into data frames through the virtual network card, so as to obtain the file data of data frame type, and then send the file data of data frame type to the PVM through the target data transmission channel, thereby realizing the data communication between the EVM and the PVM.

In the data channel building method provided in this application, the virtual network module is generated in the second virtual machine, and the target data transmission channel is built based on the first data transmission interface of the first virtual machine, the second data transmission interface of the second virtual machine for data transmission with the first virtual machine, and the virtual network module, so that the application program in the second virtual machine can perform data transmission with the first virtual machine through the target data transmission channel, and the problem that the application program cannot perform data transmission with other virtual machines is avoided.

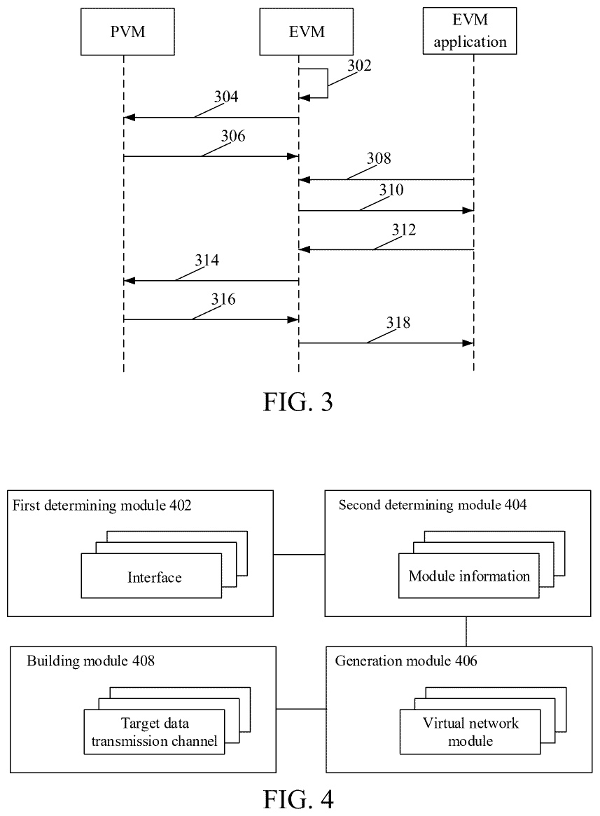

The following, with reference to FIG. 3, takes the application scenario that the data channel building method provided in this application performs data transmission in the EVM application as an example to further explain the data channel building method. FIG. 3 shows a process flow chart of a data channel building method provided by an embodiment of this application, which specifically includes the following steps.

Step 302: EVM starts and starts a virtual network card.

Specifically, the EVM starts and starts the virtual network card deployed in the EVM.

The virtual network card is deployed in the EVM, thus providing a compatible network environment for the EVM. In the process of creating the virtual network card, in order to ensure the smooth communication between the created virtual network device and the vsock front end, the virtual network device created by the EVM needs to adapt to the vsock front end. The EVM is required to determine a port type of the vsock front end deployed in itself.

Then, based on the port type, device information of the matching virtual network device is determined, where the device information includes configuration information of the virtual network interface, IP address, etc., which is required for creating the virtual network device.

Based on the device information, the EVM creates a virtual network card that is adapted to the vsock front end.

Step 304: the EVM establishes an encrypted channel between the virtual network card and the vsock.

The vsock can be understood as vsock front end in the EVM, vsock front end in PVM and vsock channel provided by the Hypervisor.

Based on this, the EVM configures the interface of the virtual network card with the vsock front end of in the EVM to realize the communication between the interface of virtual network card and the vsock front end in the EVM. The type of vsock front end and the interface of virtual network card can be determined by a socat tool.

As the vsock front end in the EVM is connected with the vsock front end in the PVM through the vsock channel provided by the Hypervisor, when the interface of the virtual network card is connected with the vsock front end in the EVM, a data transmission between the EVM application and the PVM can be built.

Step 306: the PVM informs the EVM that the channel establishment is completed.

Specifically, when the channel establishment is completed, the PVM will inform the EVM that the channel has been established and data transmission can be performed.

Step 308: the EVM application establishes a connection between the EVM application and the EVM.

Specifically, after the establishment of the secure encrypted channel for data transmission between the EVM application and the PVM is completed, the application program running in the EVM can establish a Socket connection with the EVM.

Step 310: the EVM returns a connection establishment result.

Specifically, after the establishment of Socket connection is completed, the EVM will return the connection establishment result to the EVM application.

Step 312: the EVM application transmits data through network Socket.

Specifically, the EVM application transmits data to EVM through the network Socket.

Step 314: the EVM transmits data through vsock.

Specifically, the EVM transmits data of the EVM application to the PVM through the network Socket through the encrypted secure channel established based on vsock.

Step 316: the PVM returns the data transmission result.

Specifically, after receiving the data transmitted by the EVM application, the PVM returns the data transmission result to the EVM.

Step 318: the EVM returns the data transmission result.

Specifically, after receiving the data transmission result sent by the PVM, the EVM sends the data transmission result to the EVM application through Socket.

The data channel builder provided in this manual can quickly transplant containerized services (such as a web application) to the EVM, and a standardized common service on the cloud, such as MySQL, can be pulled up in the EVM with very limited script configuration, which greatly reduces the difficulties for applications to use encrypted virtual machines.

At the same time, virtual network devices are added in the EVM to realize compatible network programming model interface, so that the network-related part of the existing application program can be migrated to the Enclave instance (that is, EVM) without fine-grained SDK transformation. Moreover, the virtual network devices in the EVM perform secure communication with the PVM through vsock, which completely reuse the security mechanism provided by the virtualization side, and connect the EVM virtual network devices through socat and other tools, and support general tools such as iptables to configure and set the virtual network interface of the EVM, which is better compatible with the ecology of the current network environment and provides convenience.

Corresponding to the above method embodiments, this application also provides an embodiment of a data channel building apparatus, and FIG. 4 shows a structural schematic diagram of a data channel building apparatus provided by an embodiment of this application. As shown in FIG. 4, the apparatus is applied to a second virtual machine running in a first virtual machine, and includes:
a first determining module 402, configured to determine a first data transmission interface of the first virtual machine and a second data transmission interface for data transmission with the first virtual machine, where the first data transmission interface is communicated with the second data transmission interface;
a second determining module 404, configured to determine module information of a virtual network module according to attribute information of the second data transmission interface;
a generation module 406, configured to generate the virtual network module according to the module information of the virtual network module; and
a building module 408, configured to build a target data transmission channel according to the first data transmission interface, the second data transmission interface and the virtual network module, where the target data transmission channel is a channel for data transmission between the first virtual machine and an application program in the second virtual machine.

In an implementation, the building module 408 is further configured to:
determine interface identification information of the second data transmission interface;
communicate the second data transmission interface with the virtual network module according to the interface identification information; and
build the target data transmission channel according to the first data transmission interface, the second data transmission interface communicated with the first data transmission interface and the virtual network module communicated with the second data transmission interface.

In an implementation, the building module 408 is further configured to:
determine a module data transmission interface of the virtual network module and module interface identification information of the module data transmission interface; and
communicate the second data transmission interface with the module data transmission interface of the virtual network module according to the interface identification information of the second data transmission interface and the module interface identification information.

In an implementation, the building module 408 is further configured to:
determine an initial data transmission channel corresponding to the first data transmission interface and the second data transmission interface, where the first data transmission interface is communicated with the second data transmission interface through the initial data transmission channel; and
build the target data transmission channel according to the initial data transmission channel, the first data transmission interface, the second data transmission interface and the virtual network module.

In an implementation, the data channel building apparatus further includes a data receiving module, configured to:
receive initial data to be processed sent by the first virtual machine through the target data transmission channel;
perform data type conversion on the initial data to be processed according to the virtual network module to obtain target data to be processed; and
process the target data to be processed according to the application program.

In an implementation, the data channel building apparatus further includes a first data sending module, configured to:
acquire a data processing result, wherein the data processing result is a result obtained by processing the target data to be processed by the application program;
perform data type conversion on the data processing result according to the virtual network module to obtain a converted data processing result; and
send the converted data processing result to the first virtual machine according to the target data transmission channel.

In an implementation, the data receiving module is further configured to:
determine a data verification unit corresponding to the virtual network module; and
perform data verification on the target data to be processed based on the data verification unit, and obtain verified target data to be processed in a case that the data verification is passed.

In an implementation, the data receiving module is further configured to:
acquire identification information of the application program from the target data to be processed, determine the application program according to the identification information; and
send the target data to be processed to the application program for processing.

In an implementation, a virtual network module is deployed in the first virtual machine, and the virtual network module is communicated with the target data transmission channel.

Accordingly, In an implementation, the data receiving module is further configured to:
receive the initial data to be processed sent by the first virtual machine through the virtual network module and the target data transmission channel communicated with the virtual network module.

In an implementation, the data channel building apparatus further includes a first data sending module, configured to:
acquire initial data to be sent generated by the application program, where the initial data to be sent includes identification information of the first virtual machine;
perform data type conversion on the initial data to be sent according to the virtual network module to obtain target data to be sent; and
send the target data to be sent to the first virtual machine through the target data transmission channel according to the identification information.

In the data channel building apparatus provided in this application, the virtual network module is generated in the second virtual machine, and the target data transmission channel is built based on the first data transmission interface of the first virtual machine, the second data transmission interface of the second virtual machine for data transmission with the first virtual machine, and the virtual network module, so that the application program in the second virtual machine can perform data transmission with the first virtual machine through the target data transmission channel, and the problem that the application program cannot perform data transmission with other virtual machines is avoided.

The above is a schematic scheme of a data channel building apparatus of this embodiment. It should be noted that the technical scheme of the data channel building apparatus belongs to the same concept as that of the above-mentioned data channel building method. For content not described in detail in the technical scheme of the data channel building apparatus, please refer to the description of the technical scheme of the above-mentioned data channel building method.

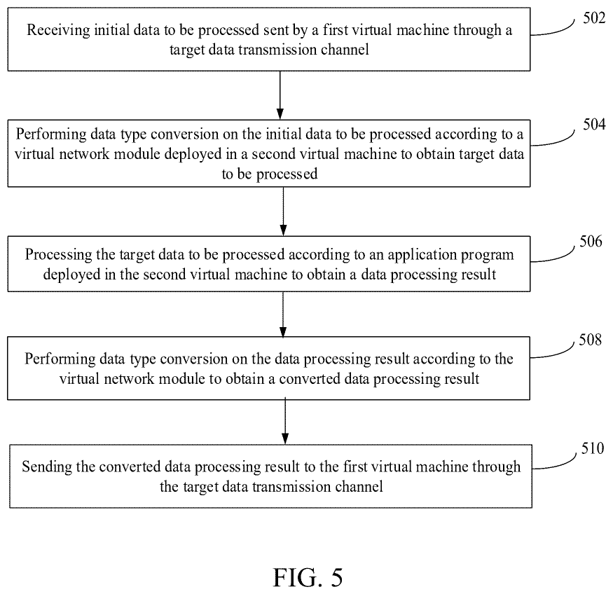

FIG. 5 shows a flowchart of a data transmission method provided by an embodiment of this application, which specifically includes the following steps.

Step 502: receiving initial data to be processed sent by the first virtual machine through a target data transmission channel.

The target data transmission channel is built according to the above data channel building method.

Step 504: performing data type conversion on the initial data to be processed according to a virtual network module deployed in the second virtual machine to obtain target data to be processed.

Step 506: processing the target data to be processed according to an application program deployed in the second virtual machine to obtain a data processing result.

Step 508: performing data type conversion on the data processing result according to the virtual network module to obtain a converted data processing result.

Step 510: sending the converted data processing result to the first virtual machine through the target data transmission channel.

The target data transmission channel in the data transmission method provided in this embodiment consists of the virtual network module created by the second virtual machine, the second data transmission interface of the second virtual machine and the first data transmission interface of the first virtual machine. For the step of creating the target data transmission channel, reference please made to the corresponding or related content in the above data channel building method, which will not be repeated in this embodiment.

It should be noted that the step of creating the virtual network module in the data transmission method provided by this embodiment can also be referred to the corresponding or related contents in the above data channel building method, which will not be repeated in this embodiment.

Specifically, in the data transmission method provided by this embodiment, after completing the creation of the virtual network module and the building of the target data transmission channel with the step of creating the virtual network module and building the target data transmission channel which can be referred to those in the above data channel building method, the second virtual machine can receive initial data to be processed sent by the first virtual machine through a target data transmission channel, and perform data type conversion on the initial data to be processed according to a virtual network module deployed in the second virtual machine to obtain target data to be processed. Then the second virtual machine processes the target data to be processed according to an application program deployed in the second virtual machine to obtain a data processing result, performs data type conversion on the data processing result through the virtual network module to obtain a converted data processing result, and sends the converted data processing result to the first virtual machine through the target data transmission channel. Therefore, the application program in the second virtual machine can perform data transmission with the first virtual machine through the target data transmission channel, and the problem that the application program cannot perform data transmission with other virtual machines is avoided.

In the following, taking the scenario that the data transmission method provided in this application in realizing EVM network interface communication as an example, the data transmission method is explained. The application program deployed in the EVM can be a web program, which needs to perform data transmission based on virtual network devices to provide web services. Based on this, after the EVM builds the target data transmission channel based on the created virtual network card, the PVM inputs the call request channel of data frame type to its own deployed vsock port, and finally transmits it to EVM's virtual network card through the vsock channel provided by Hypervisor and the vsock port deployed in the EVM. After receiving the call request of data frame type transmitted by the PVM, the EVM can convert the call request of data frame type into a call request that EVM can recognize and use through the virtual network card, and send the call request to the web application running in the EVM, so as to process the call request through the web application and obtain the data processing result of the application program for the call request.

After that, the web application in the EVM can generate a processing result for the call request after processing the call request, and then the web application can provide the processing result to the second virtual machine by transmitting data through the network Socket, and the second virtual machine can convert the data type of the processing result into a data frame through the virtual network card, so as to obtain the processing result of the data frame type, and send the processing result of the data frame type to the PVM through the target data transmission channel, thereby realizing the data communication between the EVM and the PVM.

The data transmission method provided in this application enables the data to be processed in the first virtual machine to be sent to the application program running in the second virtual for processing through the target data transmission channel machine, and the processing result of the application program can be sent to the first virtual machine through the target data transmission channel, so that the application program in the second virtual machine can perform data transmission with the first virtual machine through the target data transmission channel, and the problem that the application program cannot perform data transmission with other virtual machines is avoided.

The above is a schematic scheme of a data transmission method of this embodiment. It should be noted that the technical scheme of the data transmission method belongs to the same concept as the technical scheme of the above-mentioned data channel building method, and content not described in detail in the technical scheme of the data transmission method can be referred to the description of the technical scheme of the above-mentioned data channel building method.

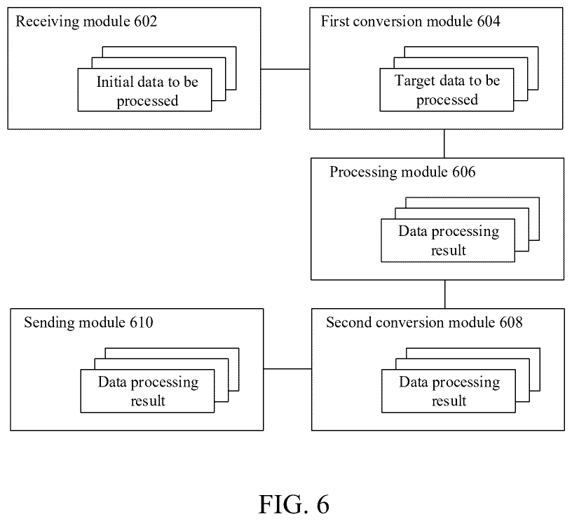

Corresponding to the above method embodiments, this application also provides an embodiment of a data transmission apparatus, and FIG. 6 shows a structural schematic diagram of a data transmission apparatus provided by an embodiment of this application. As shown in FIG. 6, the apparatus is applied to a second virtual machine running in a first virtual machine, and includes:
a receiving module 602, configured to receive initial data to be processed sent by the first virtual machine through a target data transmission channel, where the target data transmission channel is built according to the data channel building method;
a first conversion module 604, configured to perform data type conversion on the initial data to be processed according to a virtual network module deployed in the second virtual machine to obtain target data to be processed;
a processing module 606, configured to process the target data to be processed according to an application program deployed in the second virtual machine to obtain a data processing result;
a second conversion module 608, configured to perform data type conversion on the data processing result according to the virtual network module to obtain a converted data processing result; and
a sending module 610, configured to send the converted data processing result to the first virtual machine through the target data transmission channel.

The data transmission apparatus provided in this application enables the data to be processed in the first virtual machine to be sent to the application program running in the second virtual for processing through the target data transmission channel machine, and the processing result of the application program can be sent to the first virtual machine through the target data transmission channel, so that the application program in the second virtual machine can perform data transmission with the first virtual machine through the target data transmission channel, and the problem that the application program cannot perform data transmission with other virtual machines is avoided.

The above is a schematic scheme of a data transmission apparatus of this embodiment. It should be noted that the technical scheme of the data transmission apparatus belongs to the same concept as the technical scheme of the above data transmission method, and content not described in detail in the technical scheme of the data transmission apparatus can be referred to the description of the technical scheme of the above data transmission method.

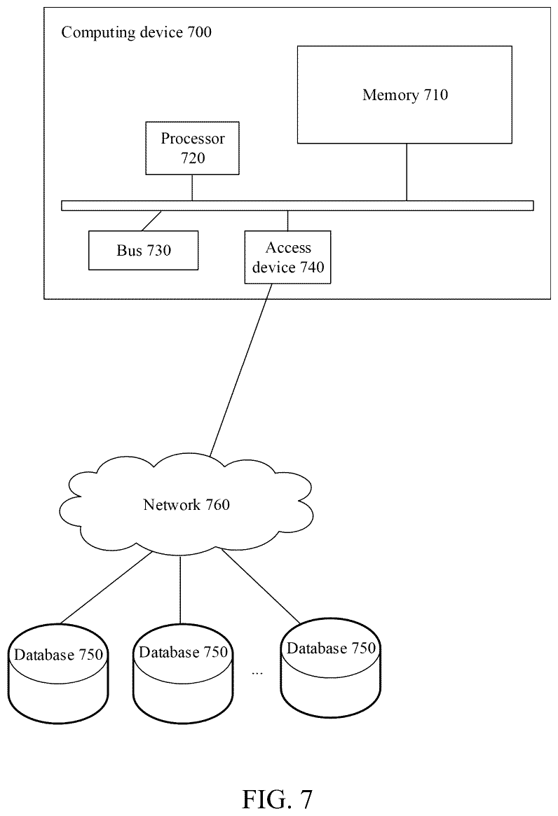

FIG. 7 shows a structural block diagram of a computing device 700 provided by an embodiment of this application. Components of the computing device 700 include, but are not limited to, a memory 710 and a processor 720. The processor 720 is connected with the memory 710 through a bus 730, and the database 750 is used for data storage.

The computing device 700 also includes an access device 740 that enables the computing device 700 to communicate via one or more networks 760. Examples of these networks include the public switched telephone network (PSTN), local area network (LAN), wide area network (WAN), personal area network (PAN) or a combination of communication networks such as the Internet. The access device 740 may include one or more of any type of wired or wireless network interfaces (e.g., network interface card (NIC)), such as IEEE 802.11 wireless local area network (WLAN) wireless interface, worldwide interoperability for microwave access (Wi-MAX) interface, Ethernet interface, universal serial bus (USB) interface, cellular network interface, Bluetooth interface, and near field communication (NFC) interface.

In one embodiment of this application, the above components of the computing device 700 and other components not shown in FIG. 7 may also be connected to each other, for example, through a bus. It should be understood that the block diagram of the computing device shown in FIG. 7 is only for a purpose of illustration, and is not intended to limit the scope of this application. Those skilled in the art can add or replace other components according to their needs.

The computing device 700 may be any type of static or mobile computing device, including mobile computers or mobile computing devices (e.g., tablet computers, personal digital assistants, laptop computers, notebook computers, netbooks, etc.), mobile phones (e.g., smart phones), wearable computing devices (e.g., smart watches, smart glasses, etc.) or other types of mobile devices, or static computing devices such as desktop computers or PCs. Computing device 700 may also be a mobile or stationary server.

The processor 720 is configured to execute computer-executable instructions that, when executed by the processor 720, realize the steps of the above data channel building method and the above data transmission method.

The above is a schematic scheme of a computing device of this embodiment. It should be noted that the technical scheme of the computing device belongs to the same concept as the technical scheme of the above data channel building method and the above data transmission method. For details not described in detail in the technical scheme of the computing device, please refer to the description of the technical scheme of the above data channel building method and the above data transmission method.

An embodiment of this application also provides a computer-readable storage medium, which stores computer-executable instructions that, when executed by a processor, realize the steps of the above-mentioned data channel building method and the above-mentioned data transmission method.

The above is a schematic scheme of a computer-readable storage medium of this embodiment. It should be noted that the technical scheme of the storage medium belongs to the same concept as the technical scheme of the above data channel building method and the above data transmission method. For details not described in detail in the technical scheme of the storage medium, please refer to the description of the technical scheme of the above data channel building method and the above data transmission method.

An embodiment of the present application also provides a computer program, where when the computer program is executed in a computer, the computer is caused to execute the steps of the above data channel building method and the data transmission method.

The above is a schematic scheme of a computer program of this embodiment. It should be noted that the technical scheme of the computer program belongs to the same concept as the technical scheme of the above data channel building method and the above data transmission method. For content not described in detail in the technical scheme of the computer program, please refer to the description of the technical scheme of the above data channel building method and the above data transmission method.

Specific embodiment of this application have been described above. Other embodiments are within the scope of the appended claims. In some cases, the actions or steps recited in the claims may be performed in a different order than in the embodiments and still achieve the desired results. In addition, the processes depicted in the drawings do not necessarily require the illustrated specific order or the sequential order to achieve the desired results. In some embodiments, multitasking and parallel processing are also possible or may be advantageous.

The computer instructions include computer program code, which can be in source code form, object code form, executable file or some intermediate form, etc. The computer-readable medium may include any entity or apparatus, recording medium, U disk, mobile hard disk, magnetic disk, optical disk, computer memory; Read-Only Memory (ROM), Random Access Memory (RAM), electric carrier signal, telecommunication signal, software distribution medium, etc, that is capable of carrying the computer program code. It should be noted that the contents contained in the computer-readable medium can be appropriately increased or decreased according to the requirements of legislation and patent practice in the jurisdiction. For example, in some jurisdictions, according to legislation and patent practice, the computer-readable medium does not include electric carrier signals and telecommunication signals.

It should be noted that for the sake of simple description, all the aforementioned method embodiments are expressed as a series of action combinations, but those skilled in the art should know that the embodiments in the present application is not limited by the described action sequence, as some steps can be performed in other sequences or performed at the same time according to this embodiment of the present application. Secondly, those skilled in the art should also know that the embodiments described in the present application are all preferred embodiments, and the actions and modules involved might not be necessary for the embodiments in this application.

In the above-mentioned embodiments, the description of each embodiment has its own emphasis. For the parts not detailed in one embodiment, please refer to the relevant descriptions of other embodiments.

The preferred embodiments of this application disclosed above are only used to help explain this application. Alternative embodiments do not describe all the details exhaustively, nor are they limit the present invention merely to the specific implementation described. Obviously, many modifications and changes can be made according to the contents of the embodiments in this application. These embodiments are selected and described in detail in this application in order to better explain the principles and practical applications of the embodiments in this application. so that those skilled in the technical field can better understand and make use of this application. This application is limited only by the claims and their full scope and equivalents.

1. A data channel building method applied to a second virtual machine running in a first virtual machine, comprising:
determining a first data transmission interface of the first virtual machine and a second data transmission interface for data transmission with the first virtual machine, wherein the first data transmission interface is communicated with the second data transmission interface;
determining module information of a virtual network module according to attribute information of the second data transmission interface;
generating the virtual network module according to the module information of the virtual network module; and
building a target data transmission channel according to the first data transmission interface, the second data transmission interface and the virtual network module, wherein the target data transmission channel is a channel for data transmission between the first virtual machine and an application program in the second virtual machine.

2. The data channel building method according to claim 1, wherein the building the target data transmission channel according to the first data transmission interface, the second data transmission interface and the virtual network module comprises:
determining interface identification information of the second data transmission interface;
communicating the second data transmission interface with the virtual network module according to the interface identification information; and
building the target data transmission channel according to the first data transmission interface, the second data transmission interface communicated with the first data transmission interface and the virtual network module communicated with the second data transmission interface.

3. The data channel building method according to claim 2, wherein the communicating the second data transmission interface with the virtual network module according to the interface identification information comprises:
determining a module data transmission interface of the virtual network module and module interface identification information of the module data transmission interface; and
communicating the second data transmission interface with the module data transmission interface of the virtual network module according to the interface identification information of the second data transmission interface and the module interface identification information.

4. The data channel building method according to claim 1, wherein the building the target data transmission channel according to the first data transmission interface, the second data transmission interface communicated with the first data transmission interface and the virtual network module communicated with the second data transmission interface comprises:
determining an initial data transmission channel corresponding to the first data transmission interface and the second data transmission interface, wherein the first data transmission interface is communicated with the second data transmission interface through the initial data transmission channel; and
building the target data transmission channel according to the initial data transmission channel, the first data transmission interface, the second data transmission interface and the virtual network module.

5. The data channel building method according to claim 1, after the building the target data transmission channel according to the first data transmission interface, the second data transmission interface and the virtual network module, further comprising:
receiving initial data to be processed sent by the first virtual machine through the target data transmission channel;
performing data type conversion on the initial data to be processed according to the virtual network module to obtain target data to be processed; and
processing the target data to be processed according to the application program.

6. The data channel building method according to claim 5, after the processing the target data to be processed according to the application program, further comprising:
acquiring a data processing result, wherein the data processing result is a result obtained by processing the target data to be processed by the application program;
performing data type conversion on the data processing result according to the virtual network module to obtain a converted data processing result; and
sending the converted data processing result to the first virtual machine according to the target data transmission channel.

7. The data channel building method according to claim 5, before the processing the target data to be processed according to the application program to obtain the data processing result, further comprising:
determining a data verification unit corresponding to the virtual network module; and
performing data verification on the target data to be processed based on the data verification unit, and obtaining verified target data to be processed in a case that the data verification is passed.

8. The data channel building method according to claim 5, wherein the processing the target data to be processed according to the application program comprises:
acquiring identification information of the application program from the target data to be processed, determining the application program according to the identification information; and
sending the target data to be processed to the application program for processing.

9. The data channel building method according to claim 5, wherein the virtual network module is deployed in the first virtual machine, and the virtual network module is communicated with the target data transmission channel;
the receiving the initial data to be processed sent by the first virtual machine through the target data transmission channel comprises:
receiving the initial data to be processed sent by the first virtual machine through the virtual network module and the target data transmission channel communicated with the virtual network module.

10. The data channel building method according to claim 1, after the building the target data transmission channel according to the first data transmission interface, the second data transmission interface and the virtual network module, further comprising:
acquiring initial data to be sent generated by the application program, wherein the initial data to be sent includes identification information of the first virtual machine;
performing data type conversion on the initial data to be sent according to the virtual network module to obtain target data to be sent; and
sending the target data to be sent to the first virtual machine through the target data transmission channel according to the identification information.

11. A data transmission method applied to a second virtual machine running in a first virtual machine, comprising:
receiving initial data to be processed sent by the first virtual machine through a target data transmission channel, wherein the target data transmission channel is built according to the data channel building method according to claim 1;
performing data type conversion on the initial data to be processed according to a virtual network module deployed in the second virtual machine to obtain target data to be processed;
processing the target data to be processed according to an application program deployed in the second virtual machine to obtain a data processing result;
performing data type conversion on the data processing result according to the virtual network module to obtain a converted data processing result; and
sending the converted data processing result to the first virtual machine through the target data transmission channel.

12. A data channel building apparatus applied to a second virtual machine running in a first virtual machine, comprising:
at least one processor and a memory;
the memory stores computer executable instructions;
the at least one processor executes the computer executable instructions stored in the memory to:
determine a first data transmission interface of the first virtual machine and a second data transmission interface for data transmission with the first virtual machine, wherein the first data transmission interface is communicated with the second data transmission interface;
determine module information of a virtual network module according to attribute information of the second data transmission interface;
generate the virtual network module according to the module information of the virtual network module;
build a target data transmission channel according to the first data transmission interface, the second data transmission interface and the virtual network module, wherein the target data transmission channel is a channel for data transmission between the first virtual machine and an application program in the second virtual machine.

13. (canceled)

14. A computer-readable storage medium storing computer-executable instructions which, when executed by a processor, causing the processor to execute the following operations:
determining a first data transmission interface of the first virtual machine and a second data transmission interface for data transmission with the first virtual machine, wherein the first data transmission interface is communicated with the second data transmission interface;
determining module information of a virtual network module according to attribute information of the second data transmission interface;
generating the virtual network module according to the module information of the virtual network module; and
building a target data transmission channel according to the first data transmission interface, the second data transmission interface and the virtual network module, wherein the target data transmission channel is a channel for data transmission between the first virtual machine and an application program in the second virtual machine.

15. The data channel building apparatus according to claim 12, wherein the processor is specifically configured to:
determine interface identification information of the second data transmission interface;
communicate the second data transmission interface with the virtual network module according to the interface identification information; and
build the target data transmission channel according to the first data transmission interface, the second data transmission interface communicated with the first data transmission interface and the virtual network module communicated with the second data transmission interface.

16. The data channel building apparatus according to claim 15, wherein the processor is specifically configured to:
determine a module data transmission interface of the virtual network module and module interface identification information of the module data transmission interface; and
communicate the second data transmission interface with the module data transmission interface of the virtual network module according to the interface identification information of the second data transmission interface and the module interface identification information.

17. The data channel building apparatus according to claim 12, wherein the processor is specifically configured to:
determine an initial data transmission channel corresponding to the first data transmission interface and the second data transmission interface, wherein the first data transmission interface is communicated with the second data transmission interface through the initial data transmission channel; and
build the target data transmission channel according to the initial data transmission channel, the first data transmission interface, the second data transmission interface and the virtual network module.

18. The data channel building apparatus according to claim 12, wherein the processor is further configured to:
receive initial data to be processed sent by the first virtual machine through the target data transmission channel;
perform data type conversion on the initial data to be processed according to the virtual network module to obtain target data to be processed; and
process the target data to be processed according to the application program.

19. The data channel building apparatus according to claim 18, wherein the processor is further configured to:
acquire a data processing result, wherein the data processing result is a result obtained by processing the target data to be processed by the application program;
perform data type conversion on the data processing result according to the virtual network module to obtain a converted data processing result; and
send the converted data processing result to the first virtual machine according to the target data transmission channel.

20. The data channel building apparatus according to claim 18, wherein the processor is further configured to:
determine a data verification unit corresponding to the virtual network module; and
perform data verification on the target data to be processed based on the data verification unit, and obtain verified target data to be processed in a case that the data verification is passed.

21. The data channel building apparatus according to claim 18, wherein the processor is specifically configured to:
acquire identification information of the application program from the target data to be processed, determine the application program according to the identification information; and
send the target data to be processed to the application program for processing.
